(19) United States
(12) Patent Application Publication
(10) Pub. No.: US 2007/0159779 A1
(43) Pub. Date: Jul. 12, 2007

(54) Figurine computer enclosure

(76) Inventor: Quentin K. Chang, La Habra, CA (US)

Correspondence Address: Rutan & Tucker, LLP.;Hani Z. Sayed, 611 ANTON BLVD, SUITE 1400, COSTA MESA, CA, 92626, US

(21) Appl. No.: 11/483,113

(22) Filed: Jul. 7, 2006

Related U.S. Application Data
(60) Provisional application No. 60/697,921, filed on Jul. 8, 2005.

(51) Int. Cl. G06F 1/16

(52) U.S. Cl. 361/683

(57) ABSTRACT

A desktop computer has an enclosure with a three-dimensional figurine shape that bear resemblance of any man-made object or natural object, imaginary character or real character, include an animal, an imaginary animal, a cartoon/anime character, a robot. The figurine enclosure also can have movable and interchangeable parts that resemble a body part of the figurine. For example, a head, an arm, a leg, a facial feature, and a tail.

This application claims priority to U.S. provisional application Ser. No. 60/697921 filed Jul. 8, 2005.

### FIELD OF THE INVENTION

The field of the invention is computer hardware, and particularly to the structural casing which commonly defines a complete enclosure of a personal computer.

### BACKGROUND

Personal computers are general-purpose devices that may be modified to perform particular tasks or functions. Personal computer typically includes motherboard, power source, and other components mounted within an enclosure. A computer enclosure is an important mechanical element in a computer system for protecting and containing the electrical elements in the computer. The enclosure generally has the capability of being used in a desktop, tower or rack-mount configuration.

Over the years, improvements in computer enclosure have been disclosed. U.S. Pat. No. 5,590,938 (herein incorporated by reference in its entirety) addresses several requirements/preferences for the frame structure including the enclosure. These improvements in computer enclosure generally provide ease of assembly, strong structural support, and reliable EMI/RFI shielding.

There has been, however, very little improvement relating to the decorative appearance of computer enclosures.

Known computer enclosures for personal computer systems are boxy, metallic, and especially unsightly if placed on top of a desk. One way of improving the unaesthetic appeal of having a boxy computer system is to simply hide it. While some computer systems can be placed under a desk, others provide a design where the boxy computer system can be placed under the computer monitor.

Conventional computer enclosures may not have sufficient strength and stiffness to withstand the weight of a computer monitor placing on top of the enclosure without deflecting and, in some instances, deforming. One answer to this problem has been to add stiffening elements to the upper cover of the enclosure. Such stiffening elements, however, may decrease the available height within the enclosure for components within the enclosure, such as expansion cards, if an overall height of the enclosure is to be maintained within specification.

Thus, there is still a need for a computer enclosure that is aesthetically appealing, personable, inviting for children, and/or expresses personality.

This and all other referenced patents and applications are incorporated herein by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

### SUMMARY OF THE INVENTION

The present invention provides apparatus, and systems in which a computer has an enclosure with a three-dimensional figurine shape.

Of particular interest are computers characterized herein as “desk top” units and computers, which are powered mostly, or entirely on external line power. This contrasts with laptops, palm computers, PDA's, cell phones, most electronic toys, toy robots, and so forth, all of which are characterized herein as “portable units” because they rely mostly on battery power.

In preferred embodiments of the inventive subject matter, the computer is adapted to connect to a data entry device, including a keyboard, a mouse, a trackball, a joystick, a gaming controller, a digital pen, and a touch screen. Also, it is contemplated that the computer is adapted to connect to a media reader that is capable of reading at least one removable media selected from the group consisting of CD, DVD, VCD, floppy disc, and flash card.

It is also contemplated that computer is adapted to connect to a communication device including a microphone, a speaker, a digital camera, a headphone, a motion sensor, and a telephone. Optionally, the communication device can be incorporated into the figurine such that the communication device appears hidden from view. For example, a digital camera can be disposed in the eye of the figurine, a speaker disposed in the mouth of the figurine.

Contemplated three-dimensional figurine can bear resemblance of any man-made object or natural object, imaginary character or real character. Examples include an animal, an imaginary animal, a cartoon/anime character, and a robot.

Contemplated figurine also can have movable parts that resemble a body part of the figurine. For example, a head, an arm, a leg, a facial feature, a tail. Optionally, such body part of the figure can be removable and interchangeable.

The three-dimensional figure enclosure can be made of different materials, including having a fabric exterior.

It is also contemplated that the wherein the personal computer system is supported by a operating system selected from the group consisting of DOS, UNIX™, Microsoft™ Windows, OS/2, and Apple™ OS.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWING

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

FIG. 1 is a perspective view of the contemplated personal computer having a figurine enclosure.

FIG. 2 is a perspective view of the contemplated personal computer having a puppy figurine enclosure.

FIG. 3 is an explosive view of the embodiment in FIG. 2.

FIG. 4 is a perspective view of another embodiment of the current invention.

### DETAILED DESCRIPTION

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

As used herein, the term “casing” is to mean “enclosure.” Both refer to the outside covering to the electrical components of a desktop personal computer.

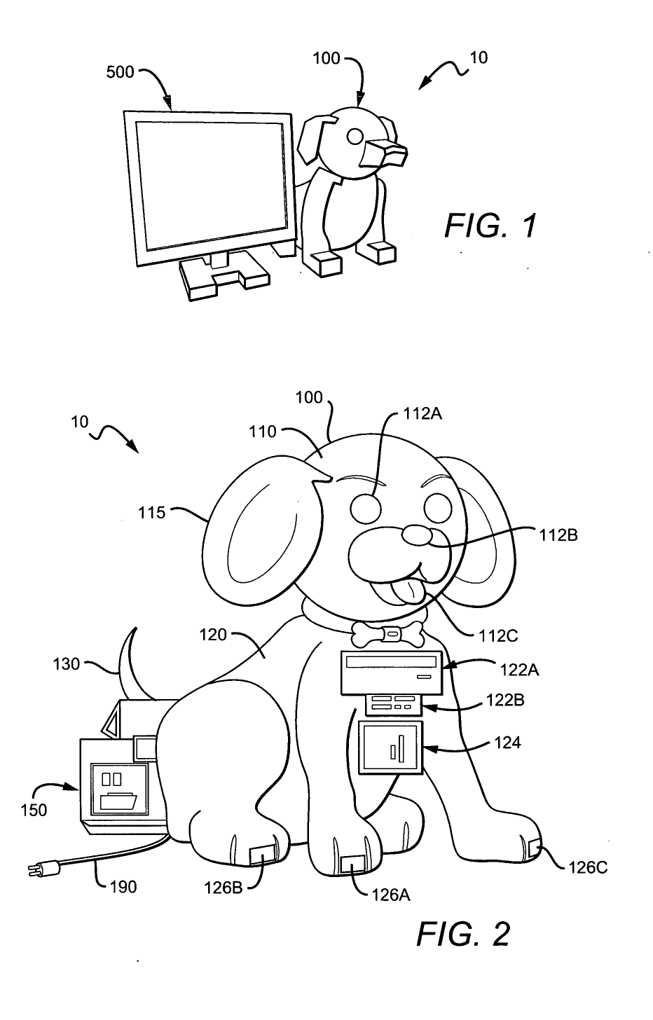

In FIG. 1, a general purpose personal computer (PC) 10 is contemplated to be any general-purpose data processing machine, including especially those especially running a popular operating systems such as DOS, VM and MVS (or IBM™ mainframes), VMS (for DEC machines), UNIX™ (including proprietary variations such as AIX, Ultrix, and UNICOS), Microsoft™ Windows, Microsoft™ PocketPC, OS/2, and Apple™ OS. Here, the computer is shown with an outer shape 100 resembling an animal. The outer shape can also be called a casing 100, or an enclosure 100. Typically, the computer is provided along with a computer monitor 500 external to the enclosure 100, a keyboard (not shown) and a mouse (not shown).

General purpose personal computer 10 generally includes a motherboard, which is the main circuit board into which can be plugged a number of smaller boards, or circuit elements. This board typically defines the backbone of a computer system. Motherboard for the contemplated embodiment is preferably relatively small, such as that used in a notebook computer. The small size is advantageous in that it allows the figurine to be relatively small as well. An especially preferred motherboard is micro ATX/BTX main board, preferably with LAN/Wi-Fi/Firewire/USB connectivity built-in. The motherboard can attach any realistic number and type of components, including for example, LAN, Wi-Fi, Firewire, Bluetooth™, USB and other communication components. Motherboard also preferably has a central processing unit socket, 2 to 4 RAM slots, 3 to 4 expansion slots, digital TV tuner, analog TV tuner, graphics board, power supply unit, cooling fan, and so forth.

Personal computer 10 typically includes a hard drive, the main drive of a computer that stores operational software as well as storage. The hard drive typically functions as the primary storage unit on personal computers, consisting of one or more magnetic media platters on which digital data can be written and erased magnetically.

As used herein, the term “desktop computer” or “personal computer,” is to mean such general purpose computers, and shall not limit to computer systems that are design to be place on the top of a desk. A desktop computer can also be a computer that is placed under a desk.

In preferred embodiments of the current invention, personal computer 10 can be coupled to data entry devices. These data entry devices generally include, for example, a keyboard (particularly those having more than 30 keys), a mouse, a trackball, a joystick, a gaming controller, a digital pen, a touch screen, and so forth.

In some embodiments, these data entry devices are electronically coupled to the personal computer 10, and are external to the computer enclosure. For example, in a typical desktop computer system, keyboard is electronically coupled to the computer (via wire or wirelessly). The keyboard, however, is external to the computer enclosure such that the keyboard is not disposed directly on the enclosure. This contrasts with laptop computers where the keyboard is enclosed within the casing of the laptop computer. This is also to distinguish from computer-embedded robots (e.g., AIBO® from Sony corporation, and Asimo humanoid robot, made by American Honda Motor Company) and consumer electronics (e.g., palm computers, PDA's, cell phones, GPS devices, stereo systems) having keypads disposed on the main body of the robots/devices.

Figurine enclosure 100 encloses general purpose computer at least partially, and preferably entirely. It is generally contemplated that the figurine enclosure can be made of any suitable material, such materials include natural and synthetic polymers, various metals and metal alloys, naturally occurring materials, textile fibers, and all reasonable combinations thereof. Further, figurine enclosure 100 can have any suitable configuration and size, preferably depicting animals, human characters, and cartoon/anime characters. Figurine coverings are preferably no bigger than 60 cm tall, 35 cm wide, and 60 cm long.

Suitable figures are “three-dimensional” in that they represent an outside image of the figurine (an animal, an imaginary animal, a robot, a human, a cartoon/anime character, etc.), or a portion of the figurine (a torso, a head, etc.) from at least front, sides, and top. The three-dimensional shape of the enclosure can also represent an outside image of non-animated objects. These generally include, for example, a transportation device (e.g., a desktop model of a car, a boat, a plane), a non-electrical household item (e.g., a flower pot, a drawer chest), and a sports item (e.g., a football). The idea is to provide a computer disclosure having other than an unsightly metallic box. The contemplated computer enclosure can be aesthetically appealing and inviting, or can be visually unimposing so as not to attract people's attention to it by blending in with other furnishings in the room. A mere facade of a cat, for example, that fits onto the front of a standard boxy computer enclosure is not considered to be “three-dimensional” as the term is used herein because the appearance of a cat is only visible from the front, and not from the sides or top. Also, it is not considered to be a three-dimensional figurine where some decoration is provided but the rectangular shape of a standard computer enclosure remains substantially visible or discernable. Therefore, the main objective of contemplated embodiments of the current invention is to provide a substantially non-rectangular computer enclosure such that the desktop computer appears non-boxy.

As shown further in Figure. 1, the personal computer 10 is coupled to an external electronic display such as a computer monitor 500.

In FIG. 2, the personal computer 10 has a figurine enclosure 100, and connects with power source via an electrical cord 190. It is also contemplated that power can be provided by a battery pack.

FIG. 2 shows an embodiment of the figurine enclosure 100, which appears as a furry-puppy stuffed animal with some fabric covering. The outside of enclosure 100 is furry and soft, although there is a metal cage inside to support and protect the electronics. The metal casing also separates the electronics from static charges from the fabric covering. It is generally contemplated that enclosure 100 can be made of suitable materials for its intended purpose to protect internal electronic components and to aesthetically appealing look/feel, such materials include natural and synthetic polymers, various metals and metal alloys, naturally occurring materials, textile fibers, and all reasonable combinations thereof.

The personal computer preferably comprises communication devices 112A-C. These communication devices generally include, for example, a microphone, a speaker, a digital camera, a headphone, a motion sensor, and a telephone.

In some embodiments of the current invention, the enclosure 100 can be designed so that these optional communication devices are incorporated within the figurine, such as in the head portion of the figurine. In FIG. 2, the personal computer has a digital camera 112A (preferably motion sensor equipped) in one of the eyes, a microphone 112B disposed in the nose, a speaker 112C disposed in the mouth. As those of ordinary skill in the art will recognize, the location and disposition of these optional devices described on the enclosure 100 can readily be modified as dictated by the aesthetic or functional needs of particular applications. Therefore, these communication devices can be located anywhere on the enclosure.

Personal computer can also have internal media reading/processing/recording drives, or can have external media reading/processing/recording drives. These drives generally include, for example, optical drives such as DVD-ROM 122A, DVD+/−RW drive, flash media reader 122B, and so forth. Contemplated media reading/processing/recording drives are capable of reading removable media. These removable media generally include, for example, CD, DVD, VCD, floppy disc, flash card, and so forth. FIG. 2 shows these devices dispose internally in the chest area of the figurine.

Preferably the enclosure 100 includes movable parts (manually or automatically). In FIG. 2, a motor allows limited movement of the head 110, ear 115, and the tail 130. Movement of the head 110 and the tail 130 can be controlled by motion sensors (not shown). One skilled in the art will appreciate other appropriate ways to control movable parts of the enclosure. For example, the enclosure can respond by moving certain parts to comments given by a user via software. Also, the puppy figurine can wags its tail and bark upon start up or reboot of the computer.

Emotion sensor equipped camera can provide utility in anti-theft or surveillance functions. For example, motion sensor equipped camera 112A disposed in the eye of the puppy enclosure starts recording of images when it senses moving object in the vicinity. Head 110 then turns to follow the movement of the subject and capture images of the moving subject. Additionally, tail 130 wags when motion senor 112A in the eye senses moving object nearby. One skill in the art will appreciate the possibility of other moving parts, such as appendages and facial features of the figurine.

As shown further in Figure. 2, a LCD touch screen 124 is optionally provided on the enclosure to display information, system status, and/or provide a way for data entry. Other electronic display screen may be provided on the enclosure 100 to display image or information. In another embodiment, the personal computer is preferably coupled to a monitor screen sized at least 25 cm diagonally across and disposed external to the enclosure. This is to distinguish from consumer electronics having an electronic display but irrelevant to the current application of a personal computer. Example of those consumer electronics includes, PDA, cellular phone, handheld GPS device, vehicle computer system with a screen on the console, a computer-embedded refrigerator with a touch screen.

The present enclosure 100 also features appropriate electrical connectors/ports 226A, 226B for coupling with external electrical devices, for example, external media drives, earphone, and speakers. One skilled in the art will appreciate all appropriate connector types for relevant purpose of connecting to external devices. These connectors types can include USB/Firewire ports (e.g., i.Link connector, USB type A and B connector), monitor connectors (e.g., HD15 15 pins, BNC connector, DB9 9 pins, 13W3 connector), printer connectors (e.g., CN36 male and female, DB25 male and female, HPCN36, MINIDIN-8, DB9 serial connector), other connectors (e.g., S-Video connector, RCA connector, SC connector ST connector fiber optic network connector MTRJ fiber optic network connector Toslink connector), and so forth.

FIG. 2 shows connectors/ports 126A, 126B at the paw of the animal figurine for connection to electrical devices. Example of these electrical devices includes, but not limited to, a keyboard, a mouse, a monitor, a media drive, an electronic display, a printer, a speaker, a digital camera, and so forth. A connector can also be provided where the personal computer can connect to a network including the World Wide Web.

In a preferred embodiment of the invention, the enclosure provides removable motherboard tray 250 for relatively easy access to the internal components in the enclosure. Contemplated enclosure can also have other mechanism similar to a sliding tray for the same purpose of providing quick access to the motherboard.

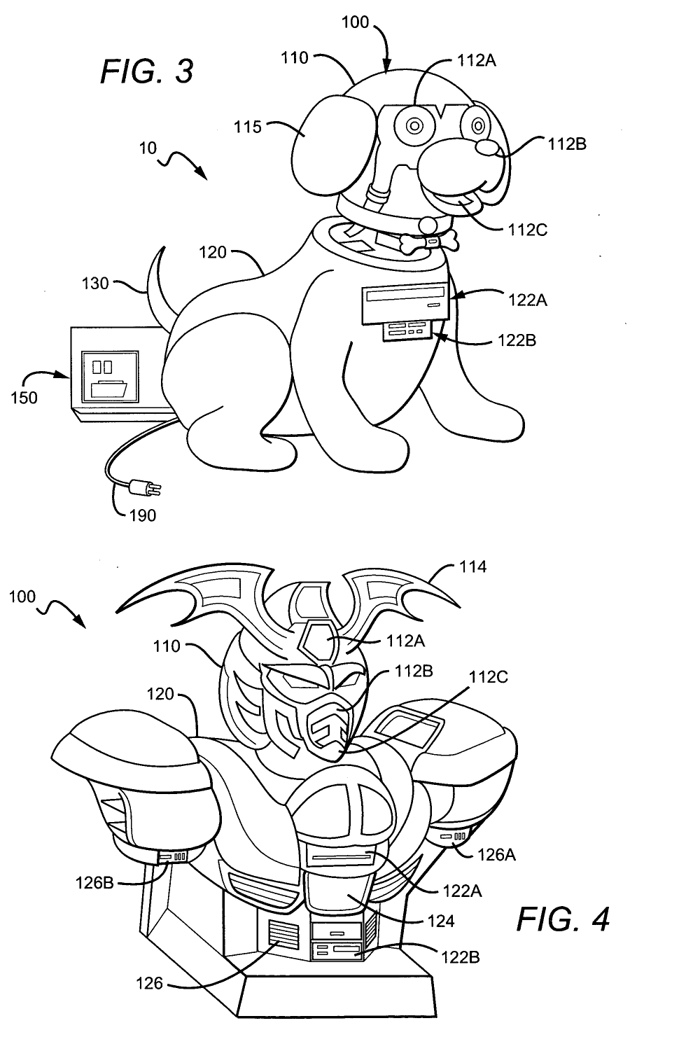

In FIG. 3, the enclosure 100 has a detachable head, and the detachable head 110 is optional interchangeable with another head 110. In this embodiment, there can be a number of figurine head designs for the same torso.

FIG. 4 illustrates an alternative to the embodiment figuring enclosure 100 where the figurine is a robot. Similar to embodiment of FIGS. 1-3, the robot embodiment has communication devices 112A, 112B, 112C disposed within the head portion of the enclosure, and these communication devices appear to be hidden from view. These communication devices generally include, for example, a microphone, a speaker, a digital camera, a headphone, a motion sensor, and a telephone. As those of ordinary skill in the art will recognize, the location and disposition of these optional devices described on the enclosure 100 can readily be modified as dictated by the aesthetic or functional needs of particular applications. Therefore, these communication devices can be located any where on the enclosure.

Optionally, a receiver antenna 114 is provided. This can be an antenna for WI-FI connectivity or other appropriate transmission such as radio frequency.

Connector/ports 126A, 126B are similarly provided in this embodiment for coupling with external electrical devices, for example, external media drives, earphone, and speakers. One skilled in the art will appreciate all appropriate connector types for relevant purpose of connecting to external devices. These connector types can include USB/Firewire ports. FIG. 2 shows connectors/ports 126A, 126B at the paw of the animal figurine for connection to electrical devices. Example of these electrical devices includes, but not limited to, a keyboard, a mouse, a monitor, a media drive, a speaker, a digital camera, and so forth. A connector can also be provided where the personal computer can connect to a network including the World Wide Web.

Media drives 122A, 122B, and touch screen 124 are optionally provided. Similarly to FIGS. 1-3, one skilled in the art will appreciate the numbers of these internal devices to be includes and their location to be disposed in the enclosure to be aesthetically appealing.

Here, enclosure 100 has a detachable and interchangeable head 110, capable of being detached from torso 120.

The embodiment illustrated in FIG. 4 is to be distinguished from computer-embedded mobile robots such as AIBO® from Sony corporation, and Asimo humanoid robot, made by American Honda Motor Company. One skilled in the art will immediate recognize that the current invention is directed towards personal computers in a non-mobile setting. More specifically, non-portable desktop computers.

Although the above description substantially deals with figurine enclosure for a desktop personal computer, it is also contemplated that a similar figurine enclosure can be provided for other types of household electronic devices typically having a boxy metallic casing, for example, PVR (personal video recorder), DVD/CD player, gaming console, VCR, and so forth.

It should be apparent to those skilled in the art that many more modifications besides those already described are possible without departing from the inventive concepts herein. Moreover, in interpreting the disclosure and the contemplated claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps could be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

Thus, specific embodiments and applications of personal computer enclosure have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A general purpose personal computer system comprising:
a three-dimensional figurine enclosure that is sized and dimensioned to enclose a general purpose personal computer having a motherboard, and a hard drive;
a media reader electronically coupled to the enclosure;
A monitor external to the enclosure and electronically coupled to the personal computer;
a data entry device external to the enclosure and electronically coupled to the personal computer; and
wherein the figurine enclosure is substantially non-rectangular.

2. The system of claim 1, wherein the data entry device is a keyboard having more than 30 keys.

3. The system of claim 1, wherein the data entry device is at least one member selected from the group consisting of a mouse, a trackball, a joystick, a gaming controller, a digital pen, a touch screen.

4. The system of claim 1 further comprising a communication device coupled to the personal computer.

5. The system of claim 4, wherein the communication device is at least one member selected from the group consisting of a microphone, a speaker, a digital camera, a headphone, a motion sensor, and a telephone.

6. The system of claim 5, wherein the communication device is disposed within a head portion of the figurine enclosure.

7. The system of claim 1 wherein the media reader is capable of reading at least one removable media selected from the group consisting of CD, DVD, VCD, floppy disc, and flash card.

8. The system of claim 1, wherein the figurine has an overall appearance of an animal.

9. The system of claim 8, wherein the animal comprises a mammal.

10. The system of claim 8, wherein the animal comprises an imaginary animal.

11. The system of claim 1, wherein the enclosure comprises at least one material from the group consisting of natural polymers, synthetic polymers, metals, metal alloys, naturally occurring materials, textile fibers, natural fibers, synthetic fibers, and polymeric material.

12. The system of claim 11, wherein the fabric is furry.

13. The system of claim 1, having an overall appearance of a cartoon/anime character.

14. The system of claim 1, having an overall appearance of a robot.

15. The system of claim 1, wherein the enclosure comprises at least one movable part having an overall appearance of at least one member selected from the group consisting of a head of the figurine, an arm of the figurine, a tail of the figurine, an eye of the figurine, an ear of the figurine, a facial feature of the figurine, a leg of the figurine.

16. The system of claim 1 wherein the figurine comprises a detachable portion having an overall appearance of a head of the figurine.

17. The system of claim 16 wherein the detachable portion is interchangeable with another head.

18. A personal computer casing for housing a motherboard and a hard drive of a personal computer system, the casing comprising:
a 3-dimensional outer shape having a likeness to a portion to at least one member selected from the group consisting of an animal, a robot, a human, a character figurine, a transportation device, a non-electrical household item, and a sports item;
the casing further defines a user access region to at least one electrical connector adapted to connect with a member selected from the group consisting of a keyboard, a mouse, a monitor, a media drive, a speaker, a digital camera, and a network such as the World Wide Web;
wherein the computer system has a monitor screen sized at least 25 cm diagonally across and disposed external to the casing.

19. The casing of claim 18, wherein the personal computer system is supported by an operating system selected from the group consisting of DOS, UNIX™, Microsoft™ Windows, OS/2, and Apple™ OS.

20. The casing of claim 19 wherein the casing is coupled to a mouse.
